(19) United States
(12) Patent Application Publication
(10) Pub. No.: US 2018/0201006 A1
(43) Pub. Date: Jul. 19, 2018

(54) METHOD AND APPARATUS FOR CONTINUOUSLY MAKING COMPOSITE STRIPS OR SHEETS

(71) Applicant: BWG BERGWERK-UND WALZWERK-MASCHINENBAU GMBH, Duisburg (DE)

(72) Inventors: Andreas NOE, Kerken (DE); Matthias STASKE, Kevelaer (DE)

(21) Appl. No.: 15/744,776

(22) PCT Filed: Sep. 20, 2016
(86) PCT No.: PCT/EP2016/072317

§ 371 Date: Jan. 13, 2018

(30) Foreign Application Priority Data
Oct. 6, 2015 (DE) 10 2015 116 990.8

(51) Int. Cl. B32B 37/02; B32B 7/08; B32B 15/20; B32B 15/085; B32B 15/088; B32B 37/10; B32B 37/20; B32B 38/18

(52) U.S. Cl. CPC B32B 37/02; B32B 7/08; B32B 15/20; B32B 15/085; B32B 15/088; B32B 2038/0096; B32B 37/203; B32B 38/1841; B32B 2250/03; B32B 2250/40; B32B 37/10

(57) ABSTRACT

The invention relates to a method for producing composite strips or composite sheets, consisting of at least a lower cover layer (1) of metal, an upper cover layer (2) of metal, and a core layer (3) of plastic, which is arranged between the cover layers (1, 2) and is integrally bonded thereto, wherein a first metal strip (4) for the lower cover layer (1), a second metal strip (5) for the upper cover layer (2), and a plastic web (6) for the core layer (3) are continuously brought together and continuously integrally bonded to each other by the application of pressure and/or heat. The method is characterized in that the metal strips are locally bonded to each other by means of a strip-bonding device as the metal strips approach the continuous process.

The invention relates to a method of making composite strips or sheets, consisting of at least one first (for example lower) outer layer of metal, one second (for example upper) outer layer of metal, and one core layer of plastic sandwiched between the outer layers and integrally joined therewith, with a first metal strip as the first outer layer, a second metal strip as the second outer layer, and a plastic web (for example plastic film) for the core layer being continuously brought together and integrally joined with one another under the application of pressure and/or heat.

Such a metal/plastic composite or sandwich sheets is used for example in automotive engineering. It serves to replace conventional steel and aluminum sheets, since it is lighter than a steel sheet on the one hand and more cost-effective than an aluminum sheets on the other. The outer sheets have for example a thickness in the range from 0.1 mm to 1 mm, and the core layer of plastic has for example a thickness of 0.05 mm to 3 mm. Such composite sheets are used in a wide range of applications in automotive engineering, such as for auto body panels for the outer skin and for structural and reinforcing parts. The sandwich sheets are characterized by a high level of flexural and buckling strength, and they also have good shaping properties, so that they have outstanding workability for processing into corresponding components. Besides the reduction in weight and cost, such sandwich sheets also make it possible to improve the acoustic and heat insulation characteristics.

During manufacturing, cold-rolled steel sheets are first made available for the cover sheets, for example, with these steel sheets generally being annealed, conditioned, and (electro-lytically) galvanized. The cover sheets manufactured in this way are then brought together as the first outer layer and second outer layer through interposition of the plastic web and joined together under pressure and/or heat as the plastic core layer is integrally joined with both the first outer layer and with the second outer layer.

A method of manufacturing composite strips or composite sheets is known from DE 10 2013 110 282, for example. There, the two cover sheets are metal sheets whose surfaces have different roughnesses. The plastic layer is made of polyamide, polyethylene, or a mixture of polyamide and polyethylene. Before the one-sided application of the plastic layer, the conditioned metal strip is first pretreated at one or more processing stations. For instance, the strip undergoes alkaline degreasing and/or cleaning at one processing station. In a subsequent processing station, the strip surface is passivated in one or more chemical pretreatment baths and thus prepared for the coating. Moreover, a processing station can be provided for the application of an adhesion promoter or adhesive on one face. After this pretreatment, a plastic layer is applied to the face of the strip to which adhesion promoter or adhesive has been optionally provided. It can be laminated as a prefabricated plastic film onto the strip, for example, such as with a laminating device having press rolls, for example, with it being possible for at least one of the rolls of the laminating device to be heated. After the application of the plastic layer, the strip that has been coated on one face passes through a cooler and/or dryer. Then, the strip is wrapped into a coil and stored for the interim, or is forwarded directly to a device for applying a cover sheet or a cover sheet that has also been coated on one face with a plastic layer. In this downstream device, two ribbon-shaped semifinished products are then brought together, each of which consists of a cover sheet and a plastic coating, with the two semifinished products being unwound from the respective decoiling reels and fed to a pair of rollers in such a way that the two plastic layers of the semifinished products face toward and lie against one another. Immediately before the semifinished products are introduced into the roll gap that is defined by the rolls, the plastic layers of both semifinished products are activated by agents acting from the plastic surface side (see DE 10 2013 110 282).

A similar method of manufacturing composite sheets is described in DE 10 2013 013 495 [US 2016/0193779]. There, the activation of the plastic layer of the semifinished products occurs directly from the side of the semifinished product that is coated with plastic. The manufacture of composite sheets is also described in WO 1991/012135.

In DE 10 2011 015 071 [US 2014/0178633] and DE 10 2012 106 206 [US 2015/0202844], corresponding sandwich sheets are described in which the plastic layer is made of fiber-reinforced plastic.

Alternatively, EP 2 193 021 [U.S. Pat. No. 8,470,111] describes a sandwich sheet in which a plastic core layer is a foam layer having a polyamide-polyethylene blend.

All things considered, a need exists for high-quality composite sheets of the type described above that can be manufactured economically using a continuous process. This is where the invention comes in.

Moreover, a method of manufacturing composite sheets with a metallic edge region is known from DE 10 2011 054 362 [US 2014/0298875], with a predetermined edge region of the composite sheet being heated such that a plastic layer disposed between the outer cover sheets softens. Through the application of force to at least one outer cover sheet in the edge region, the cover sheets are pressed directly against one another at points or contact areas, so that the plastic layer emerges in the edge region to which a force has been applied and, subsequently to or simultaneously with the application of force, the two cover sheets are joined together in the squeezed edge region at least in some areas or at some points.

Finally, DE 199 50 609 [U.S. Pat. No. 6,357,273] deals with a method of reducing the scrap length during rolling of metal strips that are joined by weld seams. In a continuous tandem mill with at least two roll stands, the weld seam is to be stopped before the roll stand or moved along at creep speed while the second roll stand continues to roll the metal strip in front of the weld seam.

It is the object of the invention to provide a generic method with which high-quality composite strips or composite sheets can be manufactured economically. In particular, the production of scrap or rejects during process startup is to be avoided or reduced.

In order to achieve this object in a method of this generic type for making composite strips or sheets, the invention teaches that the metal strips be joined together locally (near the leading end of the strip) with an (additional) strip-joining device.

The invention proceeds in this regard from the insight that, in order to produce such composite strips in a cost-effective manner, specific problems must be overcome during process startup and, above all, that excessive production of scrap and rejects must be avoided. After all, according to the invention, the two metal strips that form the outer layers are not only joined integrally with one another continuously through interposition of the plastic layer and application of pressure and heat, but rather an additional local strip-joining device is used according to the invention during startup with which the (consolidated) strips are joined together near at least one leading end of a strip in addition to or independently of the actual integral connection. Such a connection for the local joining of the two metal strips can be achieved by punching, riveting, clinching, and/or welding. Alternatively, an adhesive connection can also be considered. Such strip-joining devices are known from process lines for the manufacture of metal strips. They are used in a wide variety of stages of strip processing, such as in the working of steel strips or aluminum. According to the invention, such a strip-joining device enables the flawless startup of a process for producing composite strips. The local joining of the two metal strips ensures that the two metal strips are securely interconnected by the strip connection near the leading end of at least one strip and independently of an interposed plastic layer and independently of an integral connection via the plastic layer, so that delamination near the leading end of the strip at startup and particularly during the subsequent passage through the individual system parts is reliably prevented. The overall operational reliability of a system for producing sandwich sheets can be improved. Disruptions that can be caused by one of the strips getting caught on a roll during the ensuing process, for example, are reliably avoided. Another advantage is that strip tension can be transferred via the strip connection from one strip to another, so that there is no danger of one of the strips detaching from the other strip due to the strip tension.

Provision is made in this regard, for example, that the two metal strips (with interposition of the plastic web) are brought together and subsequently pass through a heating section together. It is especially advantageous in this context if the metal strips are joined together locally, by punching, stapling, riveting, clinching, and/or welding or gluing, after having been brought together but before being heated together. This prevents delamination near the leading end of the strip while passing through a heating section, for example.

In an especially preferred embodiment, the (two) metal strips are first joined together (locally) during process startup to form a strip segment without an interposed plastic web. It is true that the two metal strips are usually brought together during process startup with interposition of the plastic web. Nevertheless, it was recognized according to the invention that it is advantageous to first bring the two metal strips together in an upstream section without interposed plastic layer and to join the metal strips together locally in the described manner in this upstream section. Such a configuration offers the substantial advantage that, when passing through the system and particularly the corresponding heating and, optionally, pressing sections, the two surfaces of the arrangement of metal strips that is passing through is formed by metal strips from the leading end and not by the plastic strip. This will be explained in greater detail in the description of the figures.

It lies within the scope of the invention for the metal strips that are fed in and brought together during the startup process to be stopped temporarily and joined together locally while stationary using a conventional strip-joining device, for example. Alternatively, however, it also lies within the scope of the invention for the local strip connection to be produced while the strips are in motion, for example in a creep mode. This can be achieved, for example, if a strip-joining device, such as a stapler or the like, is mounted so as to be displaceable.

The strip connection is preferably created near the leading end of a strip, of for example the upper strip. In this regard, the invention proceeds from the discovery that one of the strips, the lower strip, for example, is preferably pulled completely into the system during startup, so that it is pulled through the system with commensurately provided draw rollers or a coiling reel. On the other hand, the other metal strip (the upper metal strip, for example) is then fed to the area of the joining device and brought together with the other strip (the lower strip, for example), so that the strip connection is then created near the leading end of a strip (of the upper strip, for example).

The object of the invention is also a system for making composite strips or sheets, particularly according to a method of the described type, and the composite strips or composite sheets are made of at least one first outer layer of metal, one second outer layer of metal, and one core layer of plastic that is between the outer layers and integrally joined therewith. This system has a joining device in which the metal strips can be brought together with interposition of the plastic web. Moreover, the system optionally has a heating and/or pressing device that is downstream from the joining device with which the metal strips are continuously joined in an integral matter with the plastic web under the application of pressure and/or heat, thus forming the composite strip or sandwich strip or sheet. According to the invention, this system is characterized in that an (additional) strip-joining device is in or downstream of the joining device and preferably between the joining device and the heating and pressing device for the purpose of the local joining of the metal strips during process startup.

This strip-joining device can be embodied as a punching device (stitching). Alternatively, the strip-joining device can be embodied as a riveting device in which the strips are integrally joined by separate rivets. Preferably, the strip-joining device can be embodied as a clinching device in which the strips are joined together by clinching, for example, and especially preferably by clinching without cutting edges. In this respect, a strip-joining device is a clinching device in which the strips are joined together by clinching, for example, and especially preferably by clinching without cutting edges. This means that a strip-joining device is preferably used in which the two metal strips are integrally joined with one another by mechanical means. Alternatively, however, it also lies within the scope of the invention for the strip-joining device to be embodied as a welding device. Alternatively, however, the joining of the strips can also be achieved through gluing. The adhesive can be applied for this purpose by spraying, for example. This is also possible directly in the joining device, in the calender, for example. Alternatively, a connection can also be established by adhesive tapes. The strip-joining device can thus also be integrated into the joining device.

Cover sheets made of steel sheet are especially preferably used for the production of the composite sheets in the context of the invention. However, the invention also includes the use of cover sheets made of other metals, such as aluminum or aluminum alloys or magnesium or magnesium alloys.

Cold-rolled, galvanized steel sheets, such as electrolytically zinc-plated and/or hot-dip-galvanized steel sheets, for example, are preferably used.

The metallic cover sheets preferably have a thickness of from 0.1 mm to 1 mm, preferably 0.2 mm to 0.6 mm.

The core layer of plastic can have a thickness of from 0.05 mm to 3 mm, 0.3 mm to 2 mm, for example. The indicated thicknesses refer to the finished composite web.

The plastic web is preferably embodied as a plastic film. The plastic web can be made of thermoplastic plastic such as polyethylene, polypropylene, and/or polyamide, for example. In relation to the invention, “plastic” or “plastic web” also refers to a plastic or a plastic web that is provided with additives, such as fibers, for example, with some examples being fiber-reinforced plastics and plastic webs and those containing plastic as a component. Moreover, it lies within the scope of the invention for the cover sheets to be interconnected through interposition of a plurality of plastic layers; accordingly, at least one plastic layer can be associated with each of the two outer layers, so that the two plastic layers are then joined together.

Moreover, provision is preferably made that the metal strips for the cover sheets, that is, the first cover sheet and the second cover sheet, have (substantially) the same strip width. What is more, it is advantageous if the first metal strip and the second metal strip are centered in relation to one another before or while being brought together. Common sensors and control devices working with or without feedback can be provided in the system for this purpose. For example, if the first strip passes through the system with a given strip orientation and the second band is fed to this first strip, then it is advantageous for the second strip to be centered relative to the first strip.

The invention is explained in further detail below with reference to a schematic drawing, that illustrates only one embodiment.

FIG. 1 is a simplified cross-sectional view of a composite strip or composite sheet,

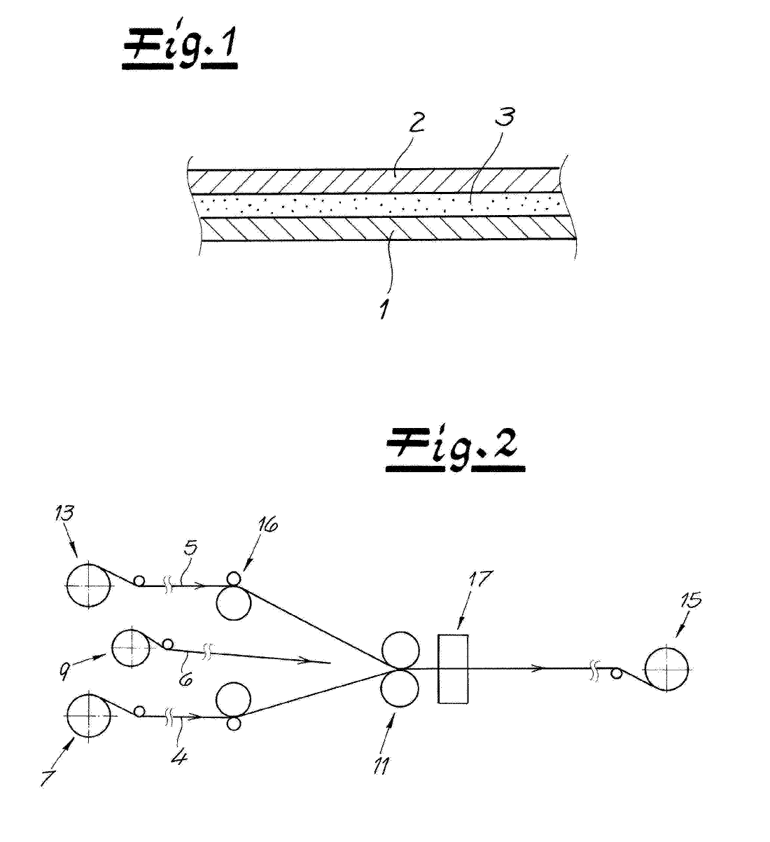

FIG. 2 is a highly simplified side view of a system for producing the composite strips according to FIG. 1,

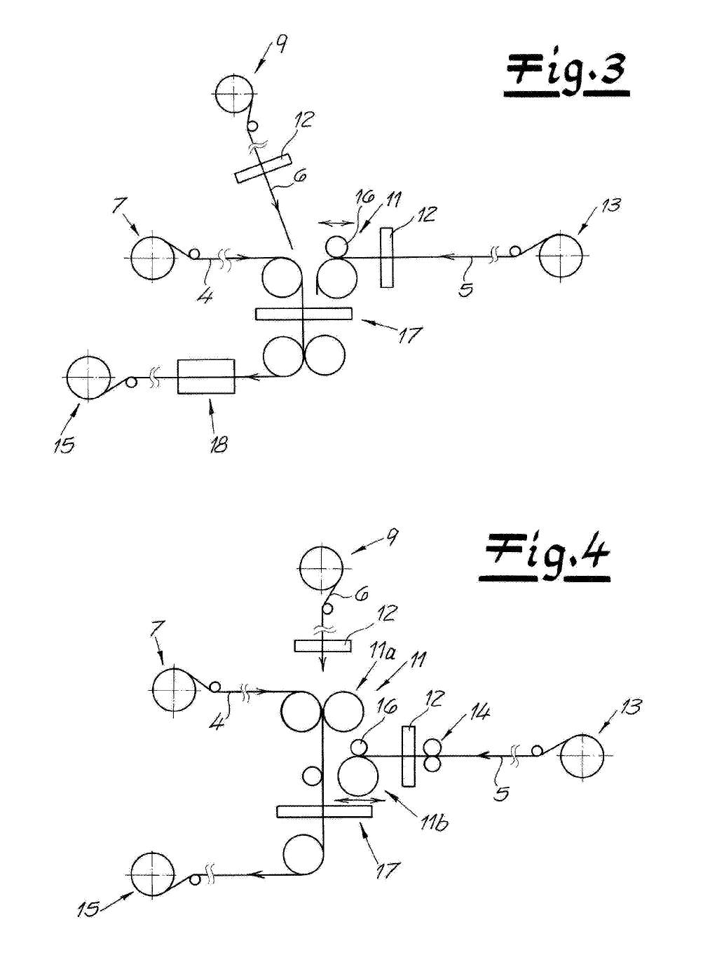

FIG. 3 shows a second embodiment of the system of FIG. 1, and

FIG. 4 shows a third embodiment of the system of FIG. 1.

With the system illustrated in FIGS. 2 to 4, composite strips or composite sheets can be produced that are made of at least one first outer layer 1 of metal, one second outer layer 2 of metal, and at least one core layer 3 of plastic that is between the outer layers 1, 2, with the outer layers 1, 2 being integrally joined with the plastic core layer 3.

In order to produce such a composite strip according to FIG. 1, a first metal strip 4 for the first outer layer and a second metal strip 5 for the second outer layer and a plastic web 6 for the core layer are supplied in the systems according to FIGS. 2 to 4. The first metal strip 4 and the second metal strip 5 and the plastic web 6 are continuously brought together and joined integrally with one another under the application of pressure and/or heat. For this purpose, at least one joining device 11 is provided in the systems.

The first metal strip 4 is unwound from a first supply reel 7 and optionally coated with an adhesion promoter. Details in this regard as well as additional optional possibilities for pretreatment are not shown in the figures. The second metal strip 5 for the second outer layer is unwound from another supply reel 13 and optionally coated with an adhesion promoter. Here as well, details regarding these and other optional possibilities for pretreatment are not shown.

The plastic web 6, which can for example be a plastic film, is unwound from a supply reel 9 and optionally preheated. Details on the preheating of the plastic web as well as on the optional preheating of the metal strips are not shown.

The first metal strip 4 and the second metal strip 5 are brought together in a continuous process with interposition of the plastic web 6, and the composite web according to the invention is produced in this way. The composite of metal strips 4, 5 and plastic web 6 can then pass through a heating and pressing section (not shown specifically) as well as through other optional system elements. The composite strip produced in this way can either be wound as a continuous strip onto a reel 15 or cut right away in the system into plates or sheets. Details are not shown.

It will readily be understood that such a system is equipped in a customary manner with appropriate drivers, tension rollers, strip-storage units, etc. Details in this regard are not shown in the figures, either.

The startup process of such a system, which is shown schematically for the sake of example in various variants in FIGS. 2 to 3, has special significance in the context of the invention. This is because, according to the invention, the metal strips 4, 5 are directly joined together locally by a strip-joining device 17 during startup of the continuous process.

FIG. 2 shows a first embodiment with substantially horizontal stock travel guide, that is, the strip connection is produced with strips that run substantially horizontally.

In the illustrated embodiment, the metal strips 4, 5 are brought together in a startup phase without the plastic web 6. The first metal strip 4 and the second metal strip 5 are thus brought together without the plastic web 6 being interposed in this startup phase. This is indicated in FIG. 2. This means that the first metal strip 4 and the second metal strip 5 first pass through the joining device 11 without interposed plastic web and arrive in the area of the strip-joining device 17 where the two metal strips are joined together without interposition of the plastic web 6, specifically locally. The strip connection produced by the strip-joining device 17 that forms a seam that extends over the width of the strip must be differentiated from the integral connection produced via the plastic web during the subsequent continuous process. Here, the strips are stopped for the strip-joining. After the strip connection has been produced, travel of the metal strips is resumed. Only after this strip connection has been produced is the plastic web 6 fed into the joining device 11, so that the local strip connection follows the desired multilayer construction.

For example, a provision is made in this regard that the first strip 4 is drawn completely into the system, so that it is pulled through the system by a draw roller (not shown) and/or the coiling reel 15. The second metal strip 5 is fed via a drive 16 with its leading end to the lower strip 4, particularly through the joining device 11, through a pair of pressure rollers, for example, and into the area of the strip-joining device 17. As soon as the leading end of the second strip 5 has reached the strip-joining device 17, the second strip 5 is also stopped, and the second strip 5 can be joined locally with the first strip 4 without the plastic web being interposed. After the connection has been established, the drive 16 can be opened, since the strip tension can then be maintained by the strip connection. The first metal strip 4 and the second metal strip 5 are then drawn together through the system, and the plastic web 6 is then also guided into the joining device 11, thus creating the desired multilayer construction.

FIG. 3 shows a modified embodiment of such a system in which the strip connection is produced not with horizontal but with substantially vertical stock guidance. In the illustrated embodiment, the first metal strip 4 is again first drawn into the system and stopped. The second strip 5 is then fed in via the drive 16. As soon as the leading end of the strip has reached the strip joiner 17, the local strip connection is created, particularly with vertical strip guidance. The joining device 11 is also embodied as a pair of rollers or as a calender that can be opened and closed. In this embodiment, the drive roller 16 is combined with the calender 11, but a separate drive 16 can also be provided. FIG. 3 shows the joining device 11 in the opened position, but the pair of rollers is closed during operation for the bringing-together of the strips. The consolidated composite of metal strips 4, 5 and plastic web 6 can then pass through an additional calender and/or a subsequent heating section and/or a heating and pressing section. This is only shown in FIG. 3 but can also be provided in the variants according to FIGS. 2 and 4.

FIG. 4 shows a modified embodiment in which the plastic web 6 is fed to the metal strips 4, 5 in two stages in the continuous process. The joining device 11 has a first laminater 11a in which the plastic web 6 is brought together with the first metal strip 4. Moreover, the joining device 11 has a second laminater 11b in which the second metal strip 5 is fed in and joined with the plastic web 6. In this embodiment as well, a strip joiner 17 is provided. During startup, the possibility thus exists of first drawing the first metal strip 4 completely into the system and stopping it. Before the plastic web 6 is fed in, the second metal strip 5 is first loaded in the second laminater 11b. As soon as the leading end of the second metal strip 5 has reached the strip joiner 17, the local strip connection occurs. The drive 16 can then be opened again, so that the strip tension of the second metal strip 5 is maintained by the strip connection. After that, the first metal strip 4 can then be drawn through the system with the second metal strip 5 fastened thereto and the plastic web 6 fed in for the continuous process.

The separated tension-guiding of the metal strips 4 and 5 shown in FIG. 4 can be implemented not only in the illustrated vertical embodiment, but also in a horizontal embodiment. Such an embodiment is not shown in the figures.

Moreover, strip shears 12 and additional drive rollers 14 are indicated in the figures which are of importance particularly when the process is momentarily stopped.

A leading-end strip connection is therefore of importance according to the invention. This offers the advantage that delamination near the leading end of the strip is prevented. Disruptions of the production process are thus prevented. This is very important in terms of the cost-effectiveness of the overall process. Moreover, in the areas of the system after the joining device 11, the plastic web is reliably prevented from being joined with the other system components and particularly rollers, for example pressure rollers, during pressing, so that the system components are also protected and disruptions avoided in this regard.

1. In a method of making composite strips or sheets consisting of at least one first outer layer of metal, one second outer layer of metal, and at least one core layer of plastic between the outer layers and integrally joined therewith, where a first metal strip for the first outer layer, a second metal strip for the second outer layer, and a plastic web for the core layer are brought together continuously and integrally joined with one another continuously under the application of pressure and/or heat, the improvement wherein the metal strips are joined directly together locally by a strip-joining device during startup of the continuous process.

2. The method defined in claim 1, wherein the metal strips are first joined together locally during process startup without an interposed plastic web.

3. The method defined in claim 1, wherein the metal strips are temporarily stopped during process startup and joined together locally while stationary.

4. The method defined in claim 1, wherein the metal strips are joined together locally during transporting of the strips, for example in a low-speed creep mode.

5. The method defined in claim 1, wherein the metal strips are joined together locally through punching, riveting, clinching, gluing, and/or welding.

6. The method defined in claim 1, wherein the metal strips are joined together locally after having been brought together and before being heated together.

7. The method defined in claim 1, wherein the metal strips are joined near the leading end of one of the strips.

8. A system for making composite strips or sheets having at least one lower outer layer of metal, one upper outer layer of metal, and one core layer of plastic between the outer layers and integrally joined therewith, the system comprising;
a joining device in which metal strips can be brought together with interposition of a plastic web, and
a strip-joining device for the local direct joining of the metal strips during process startup in the joining device or in the direction of travel of the strips downstream of same.

9. The system defined in claim 8, wherein the strip-joining device is a punching device, riveting device, clinching device, gluing device, and/or welding device.

10. The system defined in claim 8, wherein the strip-joining device is set up to produce a strip connection of moving strips by making the strip-joining device movable in the strip-travel direction.

11. The system defined in claim 8, further comprising:
a heating and/or pressing device is downstream from the joining device, with the strip-joining device being between the joining device and the heating and/or pressing device.

12. The device defined in claim 8, wherein the strip-joining device is designed for a strip connection in an approximately horizontal travel direction.

13. The device defined in claim 8, wherein the strip-joining device is designed for a strip connection in an approximately vertical travel direction.
